(19) United States
(12) Patent Application Publication
(10) Pub. No.: US 2022/0067493 A1
(43) Pub. Date: Mar. 3, 2022

(54) ELECTRONIC DEVICE WITH ARTIFICIAL INTELLIGENCE DONGLE-TYPE SUPPORTING MODULE, AND ELECTRONIC DEVICE ARTIFICIAL INTELLIGENCE SUPPORTING METHOD

(71) Applicant: Samsung Electro-Mechanics Co., Ltd., Suwon-si (KR)

(72) Inventor: Jae Goon AUM, Suwon-si (KR)

(73) Assignee: Samsung Electro-Mechanics Co., Ltd., Suwon-si (KR)

(21) Appl. No.: 17/148,731

(22) Filed: Jan. 14, 2021

(30) Foreign Application Priority Data
Aug. 27, 2020 (KR) 10-2020-0108358

(51) Int. Cl. G06N 3/063; G05B 13/02

(52) U.S. Cl. CPC G06N 3/063; G05D 1/0221; G05B 13/027

(57) ABSTRACT

A dongle-type module that supports artificial intelligence in an electronic device is provided. The dongle-type module includes an access channel configured to be connected to the electronic device; and a neural network processor, configured to receive first input information from the electronic device through the access channel, and generate, by a neural network calculation, output information based on the first input information.

### CROSS-REFERENCE TO RELATED APPLICATION(S)

This application claims the benefit under 35 USC § 119(a) of Korean Patent Application No. 10-2020-0108358 filed on Aug. 27, 2020, in the Korean Intellectual Property Office, the entire disclosure of which is incorporated herein by reference for all purposes.

### BACKGROUND

### 1. Field

The following description relates to an electronic device artificial intelligence dongle-type supporting module, and an electronic device artificial intelligence supporting method.

### 2. Description of Related Art

Typical artificial intelligence (AI) services may receive a signal from a sensor in a terminal (e.g., a mobile phone or an artificial intelligence speaker) and perform learning and reasoning processes based on the received signal with an AI cloud for actual calculations. In other words, for example, a method of sending voice input from an AI speaker to a cloud, finding an answer, based on the received voice input, in the cloud with AI, and sending the answer back to the AI speaker may be utilized. Accordingly, there has been a problem in that a minimum amount of time has been consumed to receive a result therefrom. There may also be a vulnerability to hacking because communications between locations are needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a dongle-type module configured to support artificial intelligence in an electronic device includes an access channel, configured to be connected to the electronic device; and a neural network processor, configured to receive first input information from the electronic device through the access channel, and generate, by a neural network calculation, output information based on the first input information.

The output information of the neural network processor may include pre-artificial intelligence determination information transmitted to the electronic device, and the pre-artificial intelligence determination information may be used by the electronic device to generate artificial intelligence determination information through a neural network layer of the electronic device.

The artificial intelligence determination information may include at least one of voice recognition information and image recognition information.

The dongle-type module may further include an input channel configured to provide second input information, corresponding to externally acquired information, to the neural network processor, wherein the neural network processor is configured to generate the output information based on the first input information and the second input information.

The input channel may be configured to acquire at least one of auditory information and visual information from an external source.

The output information may be transmitted to the electronic device through the access channel.

The output information may be transmitted to an extended electronic device.

The dongle-type module may further include an extended access channel, configured to be connected to the extended electronic device by one of a wired connection method and a near-field wireless connection method.

The output information of the neural network processor may be configured such that the extended electronic device is configured to control a vehicle based on the output information.

In a general aspect, a method that supports artificial intelligence in an electronic device includes connecting, to the electronic device, a dongle-type module that supports artificial intelligence in the electronic device; generating first input information corresponding to information externally acquired by the electronic device; transmitting, by the electronic device, the first input information to the dongle-type module; and receiving, by the electronic device, output information on which a neural network calculation has been performed by the dongle-type module based on the first input information.

The method may include receiving, by the electronic device, topic information from the dongle-type module; and determining whether the electronic device uses the dongle-type module based on a comparison result of comparing necessary information of the electronic device with the topic information.

The method may further include transmitting, by the electronic device, the output information to the extended electronic device.

The method may further include determining a support mode by the electronic device or the dongle-type module, wherein the generating the first input information, the transmitting the first input information, and the receiving of the output information may be selectively performed when the determined support mode is a first support mode, and the receiving of the output information further may include receiving output information on which a neural network calculation has been performed based on second input information corresponding to information acquired by the dongle-type module, when the support mode is a determined second support mode.

The method may include determining an allocation mode by one of the electronic device and the dongle-type module; and performing, by the electronic device, a neural network calculation from pre-artificial intelligence determination information to generate artificial intelligence determination information, when the allocation mode is a determined second allocation mode, wherein the output information in which the neural network calculation is performed based on the first input information or the second input information my include artificial intelligence determination information when the allocation mode is a determined first allocation mode, and may include pre-artificial intelligence determination information when the allocation mode is the determined second allocation mode.

In a general aspect, an electronic device connected to a dongle-type module that supports artificial intelligence in the electronic device includes a processor configured to generate first input information corresponding to information externally acquired by the electronic device; transmit, by the electronic device, the first input information to the dongle-type module; and receive, by the electronic device, output information on which a neural network calculation has been performed by the dongle-type module based on the first input information.

The electronic device may be configured to receive artificial intelligence determination information from the dongle-type module, and transmit the received artificial intelligence determination information to an external electronic device.

The electronic device may further include transmitting input information to the dongle-type module; receiving, from the dongle-type module, pre-artificial intelligence determination information, and generating artificial intelligence determination information from the pre-artificial intelligence determination information.

Other features and aspects will be apparent from the following detailed description, the drawings, and the claims.

### BRIEF DESCRIPTION OF DRAWINGS

FIGS. 1A to 10 are views illustrating an example dongle-type module that supports artificial intelligence in an electronic device, in accordance with one or more embodiments.

FIG. 1D is a view illustrating a shape of an example dongle-type module that supports artificial intelligence in an electronic device, in accordance with one or more embodiments.

FIGS. 2A and 2B are views illustrating an example neural network of an example dongle-type module that supports artificial intelligence in an electronic device, in accordance with one or more embodiments.

FIGS. 3A to 3E are flowcharts illustrating a method that supports artificial intelligence in an example electronic device, in accordance with one or more embodiments.

FIG. 4 is a view illustrating a neural network calculation of an example dongle-type module that supports artificial intelligence in an electronic device and a method that supports artificial intelligence in an example electronic device, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

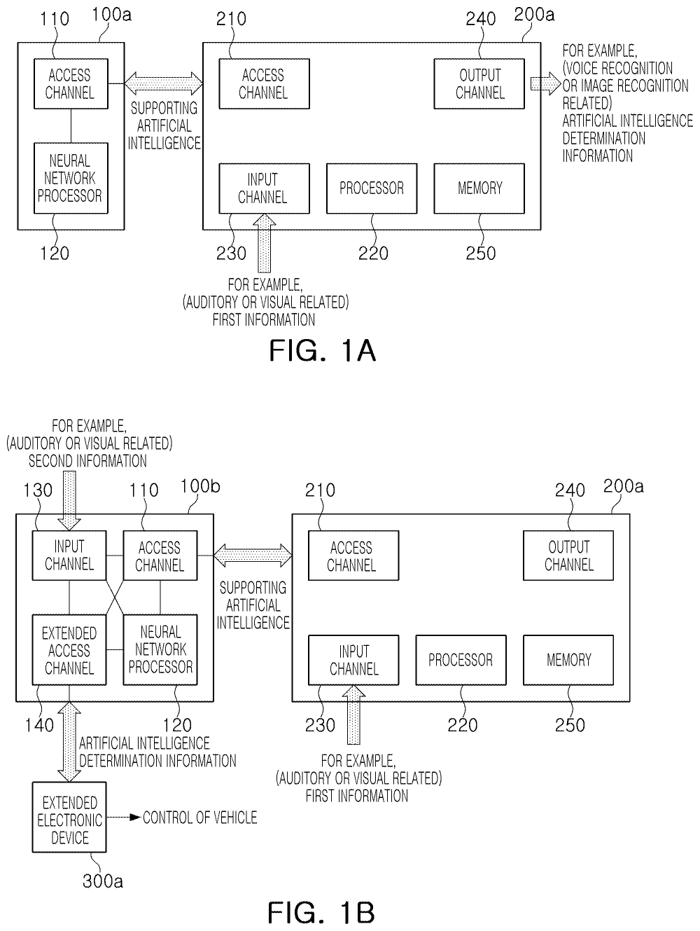

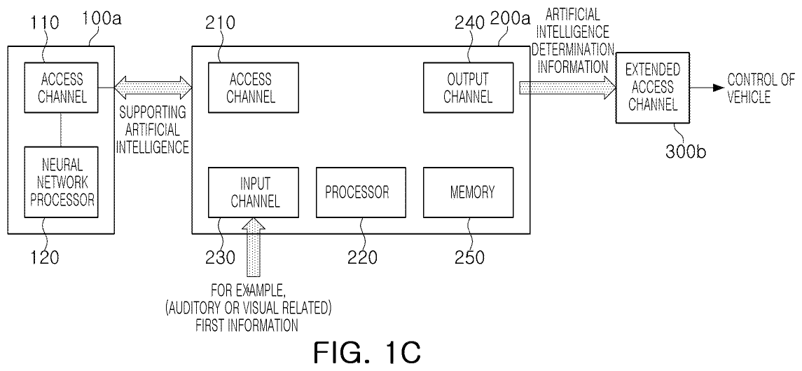

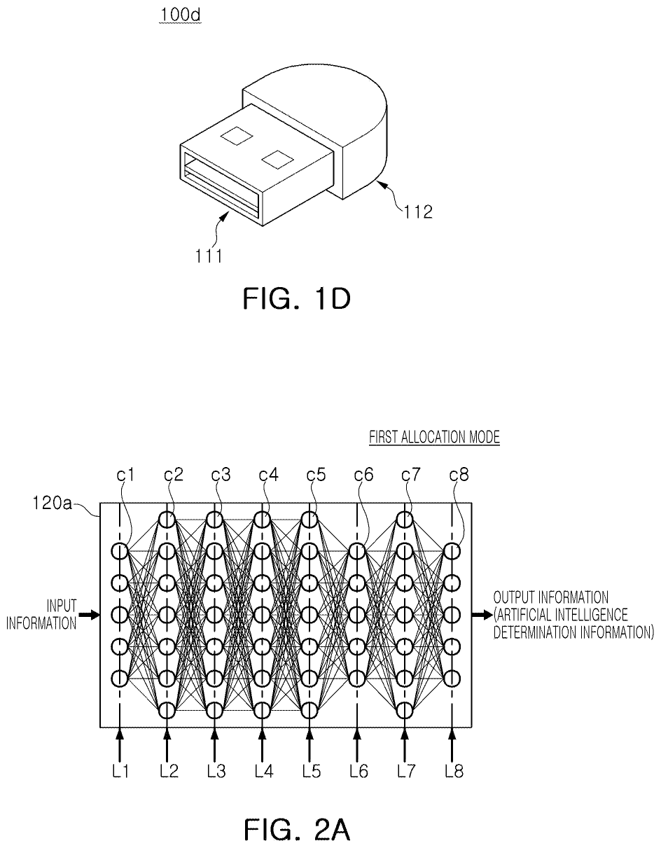

FIGS. 1A to 10 are views illustrating an example dongle-type module that supports artificial intelligence in an electronic device, in accordance with one or more embodiments.

Referring to FIG. 1A, a dongle-type module 100a that supports artificial intelligence in an electronic device, according to an example, may support artificial intelligence in an electronic device 200a, and the electronic device 200a may include at least one of an access channel 210, a processor 220, an input channel 230, an output channel 240, and a memory 250.

In a non-limiting example, the electronic device 200a may be a smartphone, a personal digital assistant, a digital video camera, a digital still camera, a network system, a computer, a monitor, a tablet computer, a laptop computer, a netbook computer, a television, components of a video game, a smartwatch, and an automotive component. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

The processor 220 may include a central processing unit (CPU), a graphic processing unit (GPU), a microprocessor, an application specific integrated circuit (ASIC), field programmable gate arrays (FPGA), or the like, and may have a plurality of cores.

Depending on a type or a design of the electronic device 200a, the processor 220 may further include a neural processing unit (NPU) that performs a neural network calculation. In an example, the electronic device 200a may or may not perform the neural network calculation according to the type or design of the electronic device 200a. When the electronic device 200a performs the neural network calculation, the dongle-type module 100a may support one or more operations necessary for the neural network calculation of the electronic device 200a. When the electronic device 200a does not perform the neural network calculation, the dongle-type module 100a may enable one or more operations necessary for the neural network calculation of the electronic device 200a.

The input channel 230 may acquire first information corresponding to first input information from the vicinity of the electronic device 200a. For example, the input channel 230 may be, as non-limiting examples, a keyboard, a mouse, a pen, a voice input channel, a touch input channel, a microphone, a camera, a video input channel, or the like. When the first information is auditory information, the input channel 230 may be a microphone. When the first information is visual information, the input channel 230 may be a camera. The first information may be converted into the first input information by at least a portion of processing operations of the processor 220. In an example, when the first input information is auditory information, the input channel 230 may sample an auditory signal for a predetermined time interval (e.g., 1/16000 seconds) to obtain an auditory waveform (the first input information).

The output channel 240 may output output information. For example, when the first information is auditory information, the output channel 240 may be a speaker. For example, when the first information is visual information, the output channel 240 may be a display member.

The output information may include artificial intelligence determination information. The artificial intelligence determination information may be information that may be derived according to inference of a human being. In an example, when the first information is auditory information in a first language (e.g., English), the artificial intelligence determination information may be auditory information in a second language (e.g., Chinese), or may be auditory information (e.g., an answer to a question) highly correlated with the first language. For example, when the first information is visual information of a face or eyes of a human being, the artificial intelligence determination information may be information on a state of being of the human (e.g., identification information, drowsiness information, virus infection information, or the like). In an example, when the first information is visual information of an object, the artificial intelligence determination information may be information on a state of the object (e.g., identification information, coordinate information, motion information, risk information, weather information, or the like).

The memory 250 may store an algorithm, a variable, or the like, used for the calculation of the processor 220. In a non-limiting example, the memory 250 may be a volatile memory (e.g., an RAM or the like), a non-volatile memory (e.g., an ROM, a flash memory, or the like), or a combination thereof, may be a storage such as a magnetic storage, an optical storage, or the like, and may store an algorithm, corresponding to a method for supporting artificial intelligence in an electronic device, in accordance with one or more embodiments.

The access channel 210 may be configured to be connected to an access channel 110 of the dongle-type module 100a, and may have a structure corresponding to the access channel 110.

Referring to FIG. 1A, the dongle-type module 100a may include an access channel 110 and a neural network processor 120.

The access channel 110 may be configured to be connected to the electronic device 200a in a dongle manner. For example, since the dongle-type module 100a may have dongle-type properties and/or a dongle-type shape, the dongle-type module 100a may be freely connected to, and separated from, the electronic device 200a by manipulation of the electronic device 200a by a user.

In an example, the access channel 110 may be implemented as a connector to be connected to the electronic device 200a in a wired manner, and may be implemented as a coil or an antenna to be connected to the electronic device 200a in a near-field communication method (e.g., Bluetooth).

In an example, when the access channel 110 is connected to the access channel 210 of the electronic device 200a, the electronic device 200a and/or the dongle-type module 100a may transmit and receive an acknowledgment signal, and the electronic device 200a may check the acknowledgment signal to recognize if the dongle-type module 100a is connected.

The neural network processor 120 may be configured to receive first input information from the electronic device 200a through the access channel 110, and generate output information by a neural network calculation based on the first input information. For example, the neural network processor 120 may be implemented as at least one neural processing unit (NPU) including a plurality of neural network layers organically connected to each other, may be mounted on a substrate such as a printed circuit board (PCB), and may be electrically connected to the access channel 110 through wiring of the substrate.

Therefore, since the electronic device 200a may receive artificial intelligence determination operations without transmitting input information to a large-scale artificial intelligence system such as an artificial intelligence cloud, hacking in a communication process of input information may be prevented before it occurs, and a period of time taken for the communication process may be reduced.

Additionally, since the dongle-type module 100a may be freely connected to and separated from the electronic device 200a, the dongle-type module 100a may perform learning necessary for at least one of artificial intelligence determination operations (e.g., language translation, human state determination, object recognition, or the like), expected to be needed by the electronic device 200a, in advance.

In an example, the dongle-type module 100a may receive a plurality of pieces of input information when connected to other electronic devices having the plurality of pieces of input information, corresponding to artificial intelligence determination operations, expected to be needed by the electronic device 200a, and the neural network processor 120 may continuously update a weight of each cell of the neural network layer of the neural network processor 120 by a neural network calculation based on the plurality of pieces of input information, to perform learning.

Therefore, since the dongle-type module 100a may support a neural network learning more efficiently, as compared to a neural network self-learning by the electronic device 200a, the electronic device 200a may obtain more accurate artificial intelligence determination information.

Additionally, the dongle-type module 100a may intensively learn a specific artificial intelligence determination operation. Therefore, since a neural network of the electronic device 200a may perform a neural network calculation, excluding a portion of required artificial intelligence determination operations, accuracy of artificial intelligence determination operations performed by the electronic device 200a itself may be improved.

Additionally, the dongle-type module 100a may be manufactured relatively simply, as compared to the electronic device 200a, and may be designed later, as compared to the electronic device 200a. Therefore, artificial intelligence determination operations, not considered in designing the electronic device 200a, may support the electronic device 200a.

Additionally, the dongle-type module 100a may be selectively connected to one of a plurality of electronic devices by manipulation of the electronic device 200a by a user. For example, the dongle-type module 100a may be fixedly disposed on a specific place, and a plurality of electronic devices may be sequentially connected to and separated from the dongle-type module 100a, as a plurality of users respectively carrying a plurality of electronic devices pass through the dongle-type module 100a.

Referring to FIG. 1B, a dongle-type module 100b that supports artificial intelligence in an electronic device, in accordance with one or more embodiments, may further include at least one of an input channel 130 and an extended access channel 140.

The input channel 130 may provide second input information corresponding to information (e.g., auditory information, visual information) externally acquired, to a neural network processor 120. The input channel 130 may correspond to an input channel 230 of an electronic device 200a.

The neural network processor 120 may generate output information (or artificial intelligence determination information) based on at least one of first input information and second input information.

Therefore, the neural network processor 120 may provide various pieces of artificial intelligence determination information.

For example, the input channel 130 and the input channel 230 may acquire images in different locations (e.g., on front and rear sides of a vehicle). The neural network processor 120 may generate determination information necessary for automatic driving of a vehicle based on the second input information, and may generate determination information necessary for automatic driving of the vehicle based on the first input information and the second input information, according to a setting.

The extended access channel 140 may be configured to be connected to an extended electronic device 300a by one or both of a wired connection method or a near-field wireless connection method. In an example, the extended access channel 140 may be connected to the extended electronic device 300a, in a similar manner to the access channel 110.

Output information generated by the neural network processor 120 may be transmitted to the extended electronic device 300a through the extended access channel 140.

In an example, the extended electronic device 300a may be a device controlling the vehicle, and in an example, may be disposed in the vehicle. In an example, artificial intelligence determination information, the output information of the neural network processor 120, may be drowsiness determination information of a driver, and the extended electronic device 300a may output a warning signal or may stop driving of the vehicle, based on the drowsiness determination information of the driver. In an example, artificial intelligence determination information that may be output information of the neural network processor 120 may be information on objects outside the vehicle, and the extended electronic device 300a may provide auditory information to the driver, based on the information pertaining to the objects outside the vehicle.

Referring to FIG. 10, an extended electronic device 300b may be connected to an electronic device 200a, and a dongle-type module 100a that supports artificial intelligence in an electronic device, in accordance with one or more embodiments, may transmit artificial intelligence determination information to the extended or external electronic device 300b through the electronic device 200a.

In an example, the electronic device 200a may transmit a calculation result transmission request signal to the dongle-type module 100a. When receiving the calculation result transmission request signal, the dongle-type module 100a may transmit output information to the electronic device 200a. The processor 220 of the electronic device 200a may convert the output information into user-desired output information, and may output the converted output information, corresponding to the user-desired output information, or may transmit the converted output information to the extended electronic device 300b.

When the number of NPUs included in a neural network processor 120 is two or more, the neural network processor 120 may provide a plurality of different artificial intelligence determination information (e.g., voice recognition information and image recognition information) together to the electronic device 200a and/or the extended electronic device 300b.

FIG. 1D is a view illustrating an example shape of an example dongle-type module that supports artificial intelligence in an electronic device, in accordance with one or more embodiments.

Referring to FIG. 1D, a dongle-type module 100d that supports artificial intelligence in an electronic device, according to an example, may include a connection member 111 and a dongle-type body 112.

The access channel illustrated in FIGS. 1A to 10 may include the connection member 111, and the neural network processor and the input channel illustrated in FIG. 1B may be disposed in the dongle-type body 112.

In an example, the connection member 111 may have a shape corresponding to an interface method such as USB, 120, and SPI.

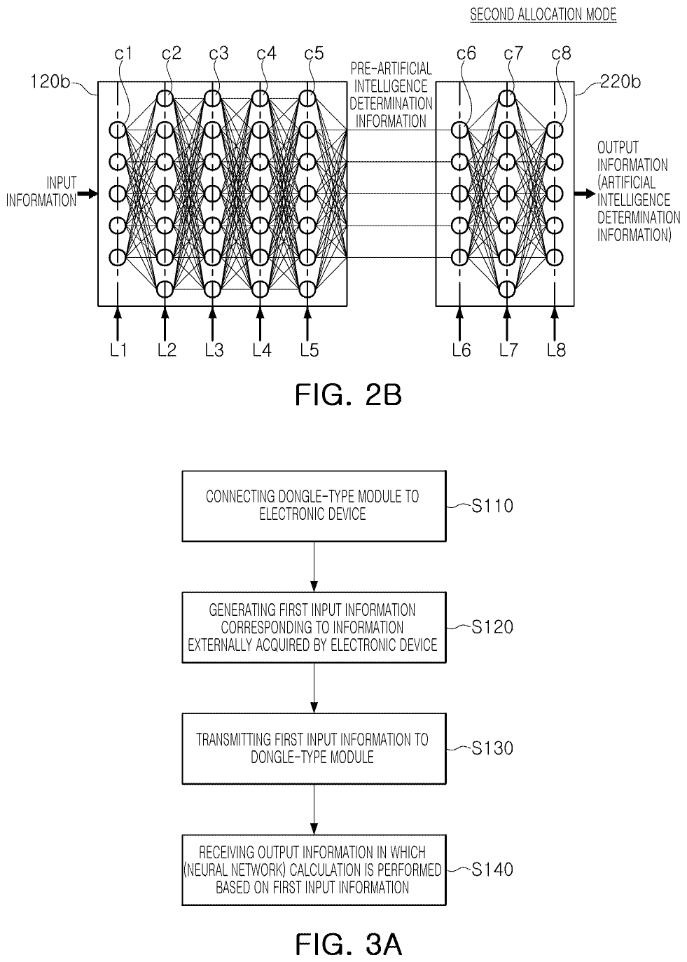

FIGS. 2A and 2B are views illustrating an example neural network of a dongle-type module that supports artificial intelligence in an electronic device, in accordance with one or more embodiments.

Referring to FIG. 2A, a neural network processor 120a in a dongle-type module that supports artificial intelligence in an electronic device, in accordance with one or more embodiments, may include a plurality of neural network layers L1, L2, L3, L4, L5, L6, L7, and L8. The plurality of neural network layers L1, L2, L3, L4, L5, L6, L7, and L8 may include a plurality of cells c1, c2, c3, c4, c5, c6, c7, and c8, respectively. The plurality of neural network layers L1, L2, L3, L4, L5, L6, L7, and L8 may be organically connected to each other.

In an example, the plurality of neural network layers L1, L2, L3, L4, L5, L6, L7, and L8 may be implemented as a convolution neural network that may recognize image data, and/or as a recurrent neural network that may recognize data having a continuous time characteristic such as a back propagation through time (BPTT) characteristic, may have a deep learning structure such as a long short-term memory (LSTM) method, and may be implemented as various type layers such as an input layer, a hidden layer, a fully connected layer, and an output layer. The plurality of neural network layers L1, L2, L3, L4, L5, L6, L7, and L8 may include different or overlapping neural network portions respectively with such full, convolutional, or recurrent connections. The neural network may be configured to perform, as non-limiting examples, object classification, object recognition, voice recognition, and image recognition by mutually mapping input data and output data in a nonlinear relationship based on deep learning. Such deep learning is indicative of processor implemented machine learning schemes for solving issues, such as issues related to automated image or speech recognition from a big data set, as non-limiting examples. The deep learning may be implemented by mapping of input data and the output data through supervised or unsupervised learning or training, such that when trained the resultant machine learning model, engine, or example NN may intuitively map further input data to output data with a desired accuracy or reliability.

In an example, when input information is auditory information, the neural network processor 120a may have a structure to which a variable, based on at least a portion of a Gaussian Mixture model and a Hidden Markov model, is applied, and may have a structure to which a variable, based on at least a portion of a Lexical Tree or Weighted Finite State Teansducer (wFST) based decoding method, is applied.

The plurality of cells c1, c2, c3, c4, c5, c6, c7, and c8 may have a weight, respectively, and the weight may be continuously updated according to input of the input information.

When an allocation mode of a dongle-type module that supports artificial intelligence in an electronic device, and/or an allocation mode of an electronic device, according to an example, is a first allocation mode, the neural network processor 120a may generate artificial intelligence determination information from the input information.

Referring to FIG. 2B, a neural network processor 120b in a dongle-type module that supports artificial intelligence in an electronic device, in accordance with one or more embodiments, may include a plurality of neural network layers L1, L2, L3, L4, and L5, and a processor 220b of an electronic device may include a plurality of neural network layers L6, L7, and L8.

When an allocation mode of the dongle-type module and/or an allocation mode of the electronic device in accordance with one or more embodiments are a second allocation mode, the neural network processor 120b of the dongle-type module may generate pre-artificial intelligence determination information from input information, and the processor 220b of the electronic device may generate artificial intelligence determination information from the pre-artificial intelligence determination information.

Therefore, since a calculation scale needed by the neural network processor 120b may be reduced, a size and costs of the neural network processor 120b may be reduced, and the dongle-type module in accordance with one or more embodiments may be implemented more efficiently as a dongle-type module.

Additionally, since the electronic device may use the neural network processor 120b of the dongle-type module to accelerate its own neural network, speed and/or accuracy of calculation of its own neural network may be efficiently improved.

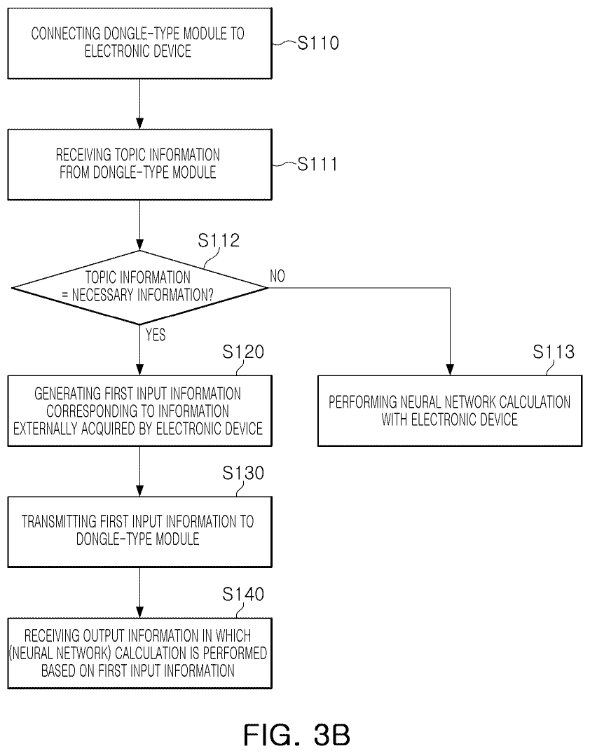

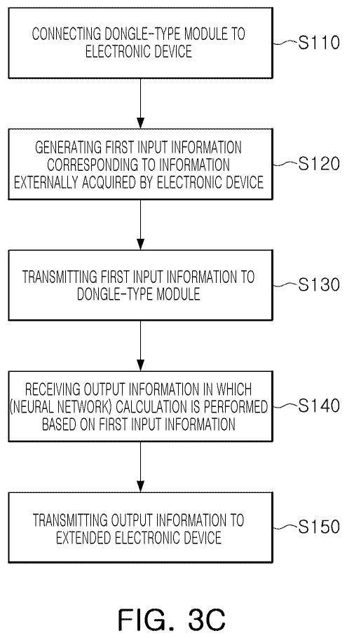

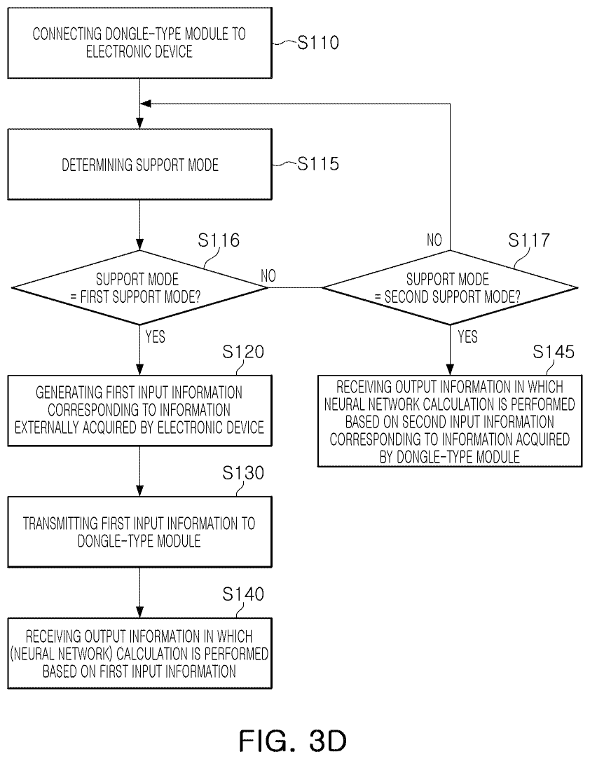

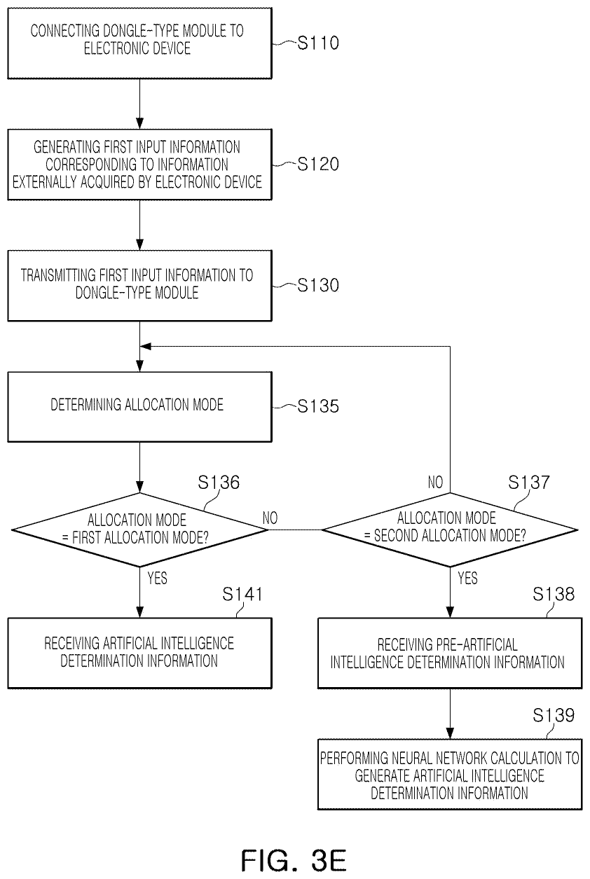

FIGS. 3A to 3E are flowcharts illustrating a method that supports artificial intelligence in an electronic device, in accordance with one or more embodiments.

Referring to FIG. 3A, a method that supports artificial intelligence in an electronic device, in accordance with one or more embodiments, may include connecting a dongle-type module that supports artificial intelligence in an electronic device to the electronic device (operation S110); generating first input information corresponding to information externally acquired (operation S120); transmitting the first input information to the dongle-type module (operation S130); and receiving output information in which a neural network calculation is performed based on the first input information by the dongle-type module (operation S140).

Therefore, since artificial intelligence determination operations may be supported by the electronic device without transmitting input information to a large-scale artificial intelligence system such as an artificial intelligence cloud, hacking in a communication process of input information may be prevented before it occurs, and a period of time taken for the communication process may be reduced.

Referring to FIG. 3B, an electronic device performing a method that supports artificial intelligence in an electronic device, in accordance with one or more embodiments, may further include receiving topic information from a dongle-type module that supports artificial intelligence of an electronic device by the electronic device (operation S111); and comparing necessary information of the electronic device with the topic information, to determine whether to use the dongle-type module based on a comparison result by the electronic device (respective operations S112 and S113).

In this example, the topic information may include at least one of identification information, sort information, type information, and learning information of an artificial intelligence determination operation provided by the dongle-type module. The necessary information of the electronic device may include at least one of identification information, sort information, type information, and learning information of an artificial intelligence determination operation requested by the electronic device.

The electronic device may efficiently know whether the dongle-type module is suitable for the electronic device based on the topic information, and collision in operations between an artificial intelligence determination operation provided by the dongle-type module and an artificial intelligence determination operation of the electronic device itself may be prevented.

Referring to FIG. 3C, an electronic device performing a method that supports artificial intelligence in an electronic device, in accordance with one or more embodiments, may further include transmitting output information to an extended electronic device (operation S150).

Since the dongle-type module may efficiently prepare an artificial intelligence determination operation specialized for the extended electronic device, an artificial intelligence determination operation that the dongle-type module provides may be utilized by various and different subjects, and compatibility of the artificial intelligence determination operation between the electronic device and the extended electronic device may be improved.

Referring to FIG. 3D, an electronic device performing a method that supports artificial intelligence in an electronic device, in accordance with one or more embodiments, may further include determining a support mode (operation S115). In this example, whether the support mode is a first support mode may be determined (operation S116), the subsequent operations (operations S120, S130, and S140) may be performed, when the support mode is the first support mode. A determination is made whether the support mode is a second support mode (operation S117), and output information in which a neural network calculation is performed is received based on second input information corresponding to information acquired by the dongle-type module, when the support mode is the second support mode, may be further included (operation S145). In an example, the first support mode may correspond to the operation of the dongle-type module and the operation of the electronic device, illustrated in FIG. 1A, and the second support mode may correspond to the operation of the dongle-type module and the operation of the electronic device, illustrated in FIG. 1B.

Therefore, a combined type of the dongle-type module and the electronic device may be further diversified, and artificial intelligence determination information that may be provided by the dongle-type module may be further diversified.

Referring to FIG. 3E, an electronic device performing a method that supports artificial intelligence in an electronic device, in accordance with one or more embodiments, may further include determining an allocation mode (operation S135). In this example, a determination may be made whether the allocation mode is a first allocation mode may be determined (operation S136), artificial intelligence determination information may be received when the allocation mode is the first allocation mode (operation S141). A determination may be made whether the allocation mode is a second allocation mode (operation S137), pre-artificial intelligence determination information may be received when the allocation mode is the second allocation mode (operation S138). A neural network calculation may be performed from the pre-artificial intelligence determination information to generate artificial intelligence determination information (S139). In an example, the first allocation mode and the second allocation mode may correspond to the first allocation mode and the second allocation mode, illustrated in FIGS. 2A and 2B, respectively.

Therefore, performance and a size of the dongle-type module may be more adaptive to the artificial intelligence determination information provided by the dongle-type module.

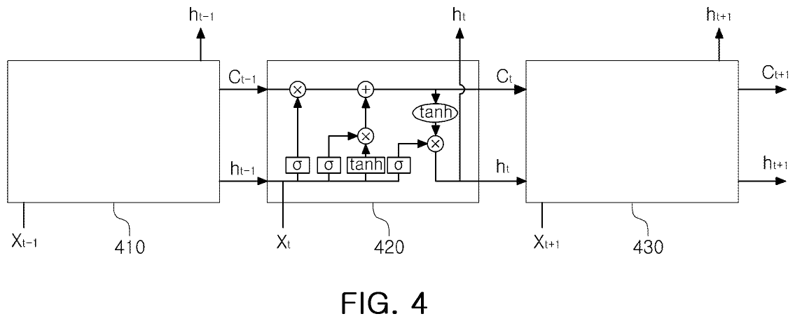

FIG. 4 is a view illustrating a neural network calculation of a dongle-type module that supports artificial intelligence in an electronic device, and a method that supports artificial intelligence in an electronic device, in accordance with one or more embodiments.

Referring to FIG. 4, a previous neural network 410 may receive previous input information Xₜ₋₁, and may output previous output information hₜ₋₁ and previous state information Cₜ₋₁.

A current neural network 420 may receive current input information Xₜ, the previous output information hₜ₋₁, and the previous state information Cₜ₋₁, and may output current output information hₜ and current state information Cₜ.

A future neural network 430 may receive future input information Xₜ₊₁, the current output information hₜ, and the current state information Cₜ, and may output future output information hₜ₊₁ and future state information Cₜ₊₁.

The neural network may use a sigmoid function (a) or a hyperbolic tangent function (tan h) on the current input information Xₜ and the previous output information hₜ₋₁, to create a variable, and may output the current output information hₜ through the variable.

The sigmoid function (a) and the hyperbolic tangent function (tan h) may be functions that output an output value of 0 to 1 when an input value is one of 0 to infinity, and may convert a non-linear input value into a linear output value, to impart dynamic characteristics to a variable creation process.

The neural network may generate the previous output information hₜ₋₁ based on the previous input information Xₜ₋₁, and may have the previous state information.

Thereafter, the neural network may use a function according to Equation 1 below to select information to be discarded from the previous state information Cm.

ƒₜ=σ(Wₜ·[hₜ₋₁,xₜ]+b_{ƒ}) Equation 1:

Additionally, the neural network may use a function according to Equations 2 to 4 below to generate information to be additionally memorized from the previous state information Cₜ₋₁, to generate the current state information Cₜ. In the examples, Wᵢ and W_{c} are first or second weight information, respectively, and b_{f} is a constant.

iₜ=σ(Wᵢ·[hₜ₋₁,xₜ]+bᵢ) Equation 2:

\tilde{C}ₜ=tan h(W_{c}·[\tilde{h}ₜ₋₁,xₜ]+b_{c}) Equation 3:

Cₜ=ƒₜ·Cₜ₋₁+iₜ·\tilde{C}ₜ Equation 4:

Additionally, the neural network may use functions according to Equations 5 and 6 below to generate the current output information hₜ.

Oₜ=σ(Wₒ·[hₜ₋₁,xₜ]+bₒ) Equation 5:

hₜ=Oₜ·tan h(Cₜ) Equation 6:

Wₜ, Wᵢ and W_{c} are first or second weight information, respectively, and b_{f}, bᵢ, b_{c}, and bₒ are constants.

According to an example, since an electronic device may receive artificial intelligence determination operations without transmitting input information to a large-scale artificial intelligence system such as an artificial intelligence cloud, hacking in a communication process of input information may be prevented before it occurs, and a period of time taken for the communication process may be reduced.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A dongle-type module configured to support artificial intelligence in an electronic device, the comprising:
an access channel, configured to be connected to the electronic device; and
a neural network processor, configured to receive first input information from the electronic device through the access channel, and generate, by a neural network calculation, output information based on the first input information.

2. The dongle-type module of claim 1, wherein the output information of the neural network processor comprises pre-artificial intelligence determination information transmitted to the electronic device, and
wherein the pre-artificial intelligence determination information is used by the electronic device to generate artificial intelligence determination information through a neural network layer of the electronic device.

3. The dongle-type module of claim 2, wherein the artificial intelligence determination information comprises at least one of voice recognition information and image recognition information.

4. The dongle-type module of claim 1, further comprising an input channel configured to provide second input information, corresponding to externally acquired information, to the neural network processor,
wherein the neural network processor is configured to generate the output information based on the first input information and the second input information.

5. The dongle-type module of claim 4, wherein the input channel is configured to acquire at least one of auditory information and visual information from an external source.

6. The dongle-type module of claim 1, wherein the output information is transmitted to the electronic device through the access channel.

7. The dongle-type module of claim 1, wherein the output information is transmitted to an extended electronic device.

8. The dongle-type module of claim 7, further comprising an extended access channel, configured to be connected to the extended electronic device by one of a wired connection method and a near-field wireless connection method.

9. The dongle-type module of claim 8, wherein the output information of the neural network processor is configured such that the extended electronic device is configured to control a vehicle based on the output information.

10. A method that supports artificial intelligence in an electronic device, the method comprising:
connecting, to the electronic device, a dongle-type module that supports artificial intelligence in the electronic device;
generating first input information corresponding to information externally acquired by the electronic device;
transmitting, by the electronic device, the first input information to the dongle-type module; and
receiving, by the electronic device, output information on which a neural network calculation has been performed by the dongle-type module based on the first input information.

11. The method of claim 10, further comprising:
receiving, by the electronic device, topic information from the dongle-type module; and
determining whether the electronic device uses the dongle-type module based on a comparison result of comparing necessary information of the electronic device with the topic information.

12. The method of claim 10, further comprising transmitting, by the electronic device, the output information to the extended electronic device.

13. The method of claim 10, further comprising determining a support mode by the electronic device or the dongle-type module,
wherein the generating the first input information, the transmitting the first input information, and the receiving of the output information are selectively performed when the determined support mode is a first support mode, and
the receiving of the output information further comprises receiving output information on which a neural network calculation has been performed based on second input information corresponding to information acquired by the dongle-type module, when the support mode is a determined second support mode.

14. The method of claim 13, further comprising:
determining an allocation mode by one of the electronic device and the dongle-type module; and
performing, by the electronic device, a neural network calculation from pre-artificial intelligence determination information to generate artificial intelligence determination information, when the allocation mode is a determined second allocation mode,
wherein the output information in which the neural network calculation is performed based on the first input information or the second input information comprises artificial intelligence determination information when the allocation mode is a determined first allocation mode, and comprises pre-artificial intelligence determination information when the allocation mode is the determined second allocation mode.

15. An electronic device connected to a dongle-type module that supports artificial intelligence in the electronic device, the electronic device comprising:
a processor configured to:
generate first input information corresponding to information externally acquired by the electronic device;
transmit, by the electronic device, the first input information to the dongle-type module; and
receive, by the electronic device, output information on which a neural network calculation has been performed by the dongle-type module based on the first input information.

16. The electronic device of claim 15, wherein the electronic device is configured to receive artificial intelligence determination information from the dongle-type module, and transmit the received artificial intelligence determination information to an external electronic device.

17. The electronic device of claim 15, further comprising:
transmitting input information to the dongle-type module;
receiving, from the dongle-type module, pre-artificial intelligence determination information, and
generating artificial intelligence determination information from the pre-artificial intelligence determination information.
